(19) United States
(12) Patent Application Publication
(10) Pub. No.: US 2005/0050450 A1
(43) Pub. Date: Mar. 3, 2005

(54) Web table editing method using table items lists

(76) Inventors: Win-Harn Liu, Taipei (TW); Jeff Song, Taipei (TW); Zhi Li, Tianjin (CN); Juen Liou, Tianjin (CN)

Correspondence Address: HARNESS, DICKEY & PIERCE, P.L.C., P.O. BOX 8910, RESTON, VA, 20195, US

(21) Appl. No.: 10/653,264

(22) Filed: Sep. 3, 2003

(51) Int. Cl. G06F 15/00

(52) U.S. Cl. 715/501.1

(57) ABSTRACT

A table editing method of the web pages using the table items lists is disclosed. The method involves establishing a list having the display setup of the entire table items, querying the lists and combining the selection of each setup of the table items to transform into a web table program code through the public function thereby displaying the web table.

### BACKGROUND OF THE INVENTION

1. Field of Invention

The invention is related to a table editing method, and more particularly to the method of dynamically editing table of web pages according to the users' requirement.

2. Related Art

The designer edits the web table using program code according to the specification or the requirement. This method is categorized as a static design method. When changing the display content or the display type, the designer has to search the original program code of the web table in order to change the web table. The search process is a waste of labor and time.

Furthermore, when meeting the web tables designed in HTML language and having the same table item of display type, the same or similar program code are only operated according to the static design method. The above-mentioned situations spend much time and work. Therefore, a method that changes or edits table items via the computer instantly is necessary.

### SUMMARY OF THE INVENTION

The main object of the invention is to provide a table editing method for the web pages using table items lists, in order to solve the problem mentioned above. The method consists of establishing lists having the entire table items, querying the lists and combining the setup selected by the user and the input data through the public function, thereby displaying the web table. The disclosed method makes the web tables displaying, and editing easy and convenient.

To achieve the object above, the method involves establishing a list having the display setup of the entire table items, querying the lists and combining the selection of each setup of the table items, to transform into a web table program code through the public function, thereby displaying the web table.

Through the brief description of the invention, the method of the invention not only solves the above problem, but also makes changing web pages tables easy and saves time.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given in the illustration below only, and thus are not limitative of the present invention:

FIG. 1 is main flow chart of the table editing method of the invention; and

FIG. 2 is the table item list of the embodiment of the invention.

### DETAILED DESCRIPTION OF THE INVENTION

The method of the invention consists of establishing lists, having the entire table items, querying the lists and combining the setup selected by the user and the input data through the public function, thereby displaying the web table. The disclosed method makes the web tables displaying, and editing easy and convenient.

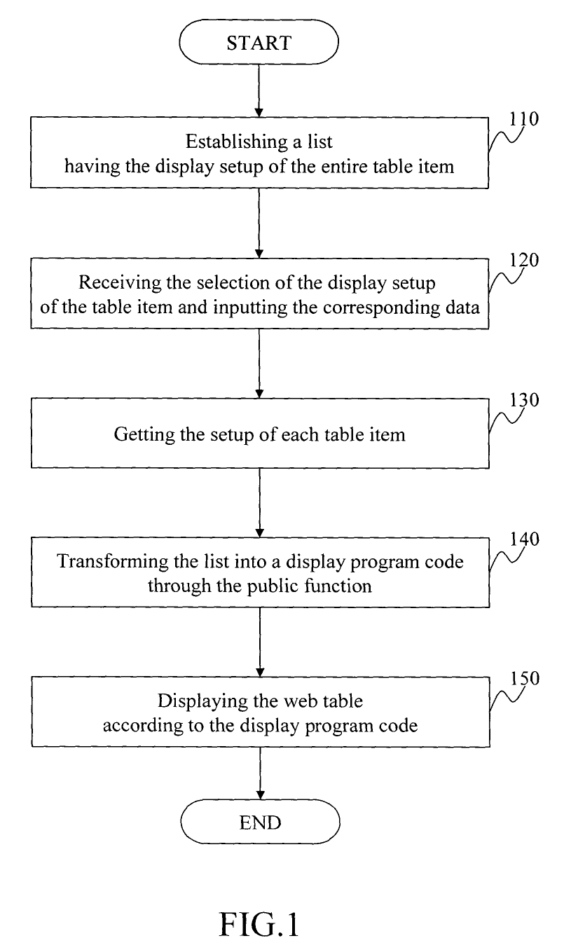

The detailed process of the table editing of the invention is as follows. Refer to FIG. 1 illustrating the main flow chart of the table editing of the invention.

The method involves establishing lists having the display setup of the entire table items (Step 110) to provide to the users, receiving the selection of the display setup of the table item and the corresponding input data (Step 120); getting the display setup of each table item (Step 130); transforming the table, required by the users, into a display program code that controls the display of the web table through the public function (Step 140); finally, displaying the web table according to the display program code.

When users start the program of table editing, the system provides a display setup option of the table items for the users, to design the web table. The display setup of each table item calls the attributes of the display setup of the table in the list. The attributes include “Item ID”, “Item Name”, “Show Type”, “Item Type”, “Parent Item”, “Show Name”, and “Long text”.

The attribute of Item ID controls the display sequence of the table item when displaying the web table. After the web table editing is completed, the Item Name controls the corresponding column name when retrieving data. The Show Type controls the display type of the table item when displaying the web table. The default display types are the text type, the list type, the check type, and the area type. The Item Type provides the data that have been stored in the program formerly such, that child options are available when the system adopts the list- or check-display type . When the designer inputs the operating system in the Item Name column, the system accesses the corresponding name database in accordance with the input. Then the corresponding names of the operating system are displayed by the system.

The Parent Item is used for indicating the corresponding name of the column when displaying the table item. It controls the corresponding name, showed in bold type. The Show Name controls the showing name when displaying the table item. The show type is setup as Text Type or pull down list type and the table column is a child option, displayed in a single line.

In the Show Type, there are many available data in the pull down list type and the check type. Each of the child options has three display control attributes, which are: ID, Type and Name. The ID controls the showing sequence for the list type and the check type. The Type provides the setup of the child option for the list type and the check type, while the Name controls the display name when the child option is the list type or the check type.

The system provides the table items to the user for editing the web tables. The system not only receives the users' selection and the input data, it also transforms the data into the display program code of the table item. So the table is displayed through the program code.

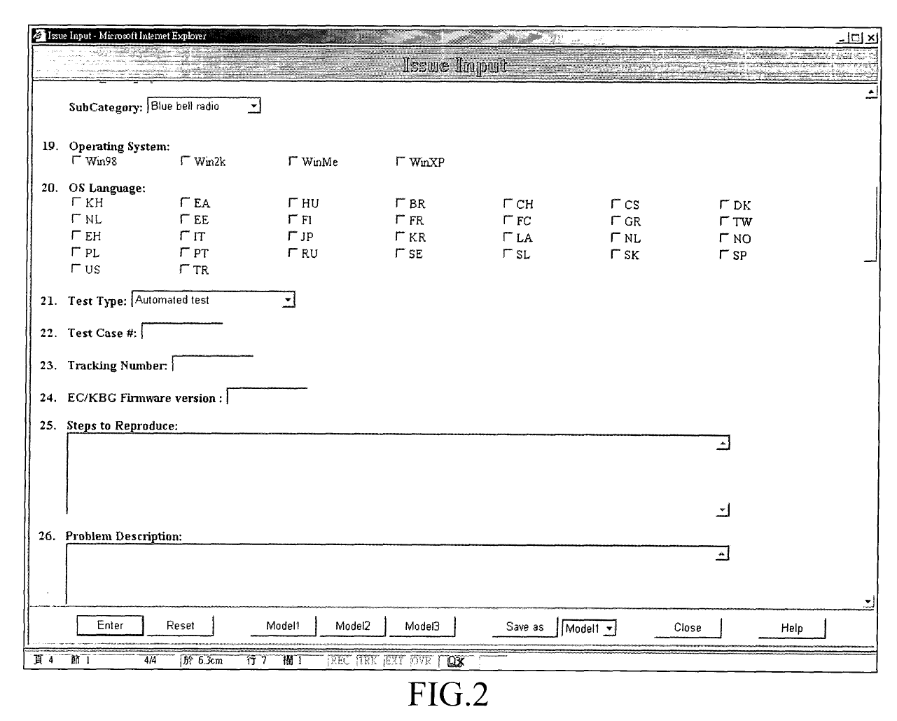

The embodiment of the invention is described as follows. Please refer to FIG. 2.

The user selects the desired setup option according to the table item provided via the user interface, and inputs text in the text column. After the selection and the input are completed, the system starts to access the data put in by the user. The public functions are the test display function, the pull down list display function, and the check display function. Then, the accessed data are transformed into the program code of the web page such, that the operating system displays the web table according to the program code.

With the invention being thus described, it will be obvious that the same may be varied in many ways. Such variations are not to be regarded as a departure from the spirit and scope of the invention, and all such modifications obvious to one skilled in the art are intended to be included within the scope of the following claims.

1. A web table editing method using the table items lists, wherein involves establishing a list having the display setup of the entire table item, querying the lists and combining the selection of each setup of the table items to transform into a web table program code through the public function thereby displaying the web table, comprising the steps of:
establishing a list having the entire display setup of the table item;
receiving the selection of the display setup of the table item and inputting the correspondent data;
editing a web table in accordance with the table items and the setup data and transforming the list into a display program code; and
displaying the web table in accordance with the display program code.

2. The method of claim 1, wherein the setup data is set according to the user's selection.

3. The method of claim 1, wherein the setup data is set according to the text input by the user.

4. The method of claim 1, wherein the table items are controlled by the attributes of an item ID, an item name, and a show type, an item type, a parent item, a show name and a long text.

5. The method of claim 4, wherein the attribute of the show type further comprises a text type, a list type, a check type and an area type.

6. The method of claim 4, wherein the attribute of item type is provided by a database.

7. The method of claim 4, wherein the attribute of the parent item controls the display result of the parent level.

8. The method of claim 4, wherein the attribute of the long text controls a child level to display in a single row.

9. The method of claim 1, wherein the public function further comprises display function of a text, a pull down list, and a checklist.
